(19) United States
(12) Patent Application Publication
(10) Pub. No.: US 2014/0263606 A1
(43) Pub. Date: Sep. 18, 2014

(54) VALVE IDENTIFICATION SYSTEM

(71) Applicant: CLARK EQUIPMENT COMPANY, West Fargo, ND (US)

(72) Inventor: Shawn R. Vasichek, Fargo, ND (US)

(73) Assignee: Clark Equipment Company, West Fargo, ND (US)

(21) Appl. No.: 13/830,650

(22) Filed: Mar. 14, 2013

(51) Int. Cl. F16K 31/02

(52) U.S. Cl. CPC F16K 31/02
USPC 235/375; 251/129.01

(57) ABSTRACT

A control system valve assembly includes a valve port, a valve stem in the valve port, and an actuator connectable to the valve stem and actuable to control a flow of hydraulic fluid through the valve port. A method for identifying and operating the control system valve assembly through an electronic controller includes incorporating a port identification tag with the valve port, the port identification tag including identification information for the valve port; incorporating a stem identification tag with the stem, the stem identification tag including identification information for the stem; incorporating a reading device with the actuator; reading the identification information from the port identification tag and the stem identification tag with the reading device; communicating the identification information read by the reading device to the electronic controller; and operating the valve assembly with the electronic controller consistent with the identification information.

### BACKGROUND

This disclosure relates to valve identification systems and methods for identifying valve assemblies in a hydraulic control system. One specific application for the invention is a valve identification system for a control system for a power machine.

Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices) that can be manipulated to perform a work function. Some examples of work vehicle power machines include loaders, excavators, utility vehicles, tractors, and trenchers, to name a few.

Power machines generally, and work machines in particular, often use power conversion systems that selectively provide pressurized hydraulic fluid to actuators to perform certain tasks. Valve assemblies are often provided for controlling the flow of pressurized hydraulic fluid to a number of these actuators on a power machine. Many power machines have several of these valve assemblies into a single valve body with each of these valve assemblies being electrically controlled by an electronic controller. This plurality of valve assemblies are often in close proximity with each other and are connected to the electronic controller by distinct wiring connections. To ensure proper operation of the power machine, the electronic controller must provide proper operating signals to the intended valve assemblies.

### SUMMARY

In one embodiment, the disclosure provides a method for identifying and operating a control system valve assembly through an electronic controller. The valve assembly includes a valve port, a valve stem that is removably inserted in the valve port, and an actuator that is connectable to the valve stem and is actuable to control a flow of hydraulic fluid through the valve port. The method includes incorporating a port identification tag including identification information for the valve port with the valve port; incorporating a stem identification tag including identification information for the stem with the stem, and incorporating a reading device with the actuator. The method further includes reading the identification information from the port identification tag and the stem identification tag with the reading device and communicating the identification information read by the reading device to the electronic controller. The valve assembly is operated by the electronic controller based on the identification information in response to operating commands.

The valve port may be included in a valve block that includes multiple valve ports; and the method, in some embodiments, includes incorporating a port identification tag with each valve port in the valve block, such that each valve port in a valve assembly includes a unique port identification tag. The method may further include identifying the position of the valve stem in the valve block through the port identification tag associated with the valve port in which the valve stem is received. The port identification tag may be provided in the form of a radio frequency identification tag and the reading device may be provided in the form of a radio frequency transceiver. The electronic controller may be programmed with expected combinations of valve stem identification information and valve port identification information and the method may further include comparing the valve stem identification information and valve port identification information to the expected combinations and identifying an exception condition if an expected combination is not met.

In another embodiment, the disclosure describes a control assembly that includes an electronic controller and a plurality of valve assemblies. Each valve assembly includes a valve port including a port identification tag, a valve stem including a stem identification tag received in the valve port, and an actuator connected to the valve stem. Each actuator includes a reading device for reading identification information from each of the port identification tag and stem identification tag and a communication link between the reading device of each valve assembly and the electronic controller. The electronic controller receives the identification information for each valve port and stem arrangement of each valve assembly and the electronic controller operates the valve assemblies according to the identification information to perform a desired operation.

In another embodiment, the disclosure describes a power machine including an electronic controller and a plurality of user input devices in communication with the electronic controller such that commands provided by the operator through manipulation of the user input devices are received by the electronic controller. A control system includes a plurality of valve assemblies, with each valve assembly including a valve port, a valve stem in the valve port, and a valve actuator interconnected to the valve stem within the valve port and actuable to control a flow of hydraulic fluid through the valve port. A valve port identification tag is incorporated with each valve block and a stem identification tag is incorporated with each valve stem, and a reading device is incorporated with each valve actuator. The reading device receives identification information from the valve port identification tag and stem identification tag in the valve assembly. A communication link exists between each valve assembly and the electronic controller. The electronic controller receives the identification information from each valve assembly and determines a position of each valve stem in the control system. The electronic controller executes the commands received from the operator through the user input devices by actuating the appropriate valve assemblies. The electronic controller controls at least one function of the power machine through the control system.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a perspective view of a power machine in the form of an excavator upon which the disclosed embodiments may be practiced.

FIG. 2 is a schematic illustration of a portion of a control system according to one illustrative embodiment of the present disclosure.

FIG. 3 is a flowchart of a method of operating the control system of FIG. 2.

### DETAILED DESCRIPTION

Before any embodiments are explained in detail, it is to be understood that the concepts discussed in the embodiments set forth herein are not limited in their application to the details of construction and the arrangement of components set forth in the following description or illustrated in the following drawings. The terminology in this discussion provides description of some embodiments and should not be regarded as limiting. The use of “including,” “comprising,” or “having” and variations thereof herein is meant to encompass the items listed thereafter and equivalents thereof as well as additional items.

FIG. 1 illustrates a perspective view of a power machine 100 of the type on which the disclosed embodiments can be employed. The power machine 100 illustrated in FIG. 1 is a work vehicle in the form of a self-propelled power excavator, but other types of work vehicles such as skid-steer loaders, tracked loaders, steerable wheeled loaders, including all-wheel steer loaders, telehandlers, walk-behind loaders and utility vehicles, as well as other power machines may employ the disclosed embodiments. Power machine 100 has a chassis or undercarriage 102 and an upper rotatable frame 104. Undercarriage 102 includes a lower frame 106 and a pair of support surface engaging tractive elements 108 in the form of track assemblies that are attached to the lower frame 106 and driven with a suitable drive arrangement, such as with hydraulic drive motors. Upper rotatable frame 104 supports a pivotally mounted two-section boom-arm structure 110, which illustratively includes both a boom section and an arm section, capable of having an implement 112 (a bucket is shown in FIG. 1) attached to an outer end thereof. The sections of boom-arm structure 110 are illustratively operated with actuators shown generally at 114 for moving the boom sections about horizontal pivots. Implement 112 is also operated with an actuator 116 to allow for pivotable movement with respect to the boom-arm structure 110. Actuator 116 is coupled to a link 160, which in turn is attached to an implement carrier 162 that accepts and secures implement 112 to the boom-arm structure 110. Upper rotatable frame 104 also includes an operator compartment 118 and a housing 120 for an engine for providing power to the suitable drive arrangement that drives the pair of ground engaging tractive elements 108. A plurality of actuable input devices 119 are positioned within the operator compartment 118 to allow an operator to control functions of the machine including, for example, the drive function and manipulation of the boom-aim structure 110 and the implement 112.

The power machine 100 illustrated in FIG. 1 also includes an implement assembly 122, which is operably coupled to the lower frame 106. The implement assembly 122 illustratively includes a pair of lift arms 124 that are rotatably coupled to the lower frame 106 at pivot joints 126. A pair of actuators 128 is also coupled to the lower frame 106 and lift arms 124. A blade 130 is illustratively coupled to the lift arms 124. In one embodiment, the blade 130 is fixedly attached to each of the lift arms 124. Alternatively, the blade 130 can be attached to an attachment mechanism such as a cross member (not shown) that is in turn attached to the lift arms. As another example, the blade 130 can be pivotally mounted to the lift arms 124. The actuators 128 are capable of rotating the lift arms 124 with respect to the lower frame 106 to raise and lower the blade 130. While FIG. 1 shows two actuators 128, alternatively, a single actuator may be employed to control the annular position of the lift arms 124 with respect to the lower frame 106. Alternatively still, the implement assembly 122 can include an implement carrier that is operably coupled to the lift arms to accept any of a number of different implements rather than having an implement assembly with a dedicated implement intended to be permanently coupled thereto as is shown in the blade example in FIG. 1. An example of such an implement carrier is illustrated in U.S. Pat. No. 8,024,875 of Wetzel et al., incorporated herein by reference.

In exemplary embodiments, the power machine 100 includes a power source 140 that in some embodiments is an internal combustion engine. A control system or power conversion system 142 is operably coupled to the power source 140. Control system 142 illustratively receives power from the power source 140 and operator inputs to convert the received power to signals that operate functional components of the power machine 100. In some embodiments, such as with the power machine 100 of FIG. 1, the control system 142 includes hydraulic components such as one or more hydraulic pumps that provide pressurized hydraulic fluid to various actuators and valve components that are illustratively employed to control the flow of hydraulic fluid to some or all of the actuators used to control functional components of the power machine 100. Other types of control systems are also contemplated. For example, the control system 142 may include electric generators or the like to generate electrical control signals to power electric actuators. For the sake of simplicity, the actuators disclosed herein are referred to as hydraulic or electrohydraulic actuators, but other types of actuators can be alternatively employed.

Among the functional components that are capable of receiving signals from the control system 142 are tractive elements 108, illustratively shown as track assemblies 108, which engage a support surface rotatably to cause the power machine to travel. In other embodiments, such as certain loader and excavator embodiments, the tractive elements can be wheels. In an example embodiment, a pair of hydraulic motors (not shown in FIG. 1), are provided to convert a hydraulic power signal into a rotational output for left and right sides of the machine. In other embodiments, differing numbers of hydraulic motors can be employed. Other examples of functional components that are capable of receiving signals from the control system 142 are actuators 114 and 116 that, as described above, are used to manipulate boom-arm structure 110 and implement 112. Still other examples of functional components that are capable of receiving signals from the control system 142 include actuators that are used to swing the boom-arm structure 110 relative to the upper frame 104 and rotate the upper frame 104 relative to the undercarriage 102 (none of which are shown in FIG. 1). Yet another example of actuators that can be controlled by control system 142 are actuators on an implement that is operatively coupled to power machine 100. The functional components listed here are but examples of the types of functional components that may be controlled by control system 142. Other excavators may employ control systems with valve assemblies that control some, all, none, or different functions than those listed here. Other work vehicles and, more broadly, other power machines may likewise employ a control system like control system 142 to control similar types of actuators.

In exemplary embodiments, the control system 142 includes an electronic controller 200 (shown in FIG. 2). The electronic controller 200 is configured to receive input signals from the operator's manipulation of at least some of the operator input devices 119 and operate valve assemblies of the hydraulic components of the control system 142 to perform a desired operation. The electronic controller 200 is configured to control at least one function of the power machine 100 through at least one of the plurality of output valve ports of the electronic controller 200. The electronic controller 200 can be a single electronic control device with instructions stored in a memory and a processor that reads and executes the instructions to receive input signals and provide output signals all contained within a single enclosure. Alternatively, the electronic controller 200 can be implemented as a plurality of electronic devices that may (or may not) be coupled on a network. The embodiments described herein are not limited to any single implementation of an electronic control device or devices. The electronic device or devices such as the electronic controller 200 are programmed and configured by the stored instructions to function and operate as described.

FIG. 2 illustrates embodiments of a valve portion of the control system 142 of the power machine 100, which can include one or more valve assemblies 210, 210′, 210″. Each of the valve assemblies, either alone or in combination, with other valve assemblies, can control a functional component of type described above. The valve assemblies 210, 210′, 210″ may be incorporated in the main body of the power machine 100 as part of the standard vehicle control system 142, or may be incorporated in an attachable implement 112 and interface or plug in with the vehicle control system 142. The valve assemblies 210, 210′, 210″ are substantially identical to each other, so the following description will refer only to the first valve assembly 210, it being understood that similar or identical components of the other valve assemblies 210′, 210″ are shown in the drawings with prime and double-prime marks on the same reference numbers.

Valve block 220 includes at least one valve port 221 formed therein, at least one port identification tag 222, at least one valve stem 230 removably inserted in the valve port 221, at least one stem identification tag 231, and at least one actuator 240 connected to the valve stem 230 for actuating the valve stem 230 in the valve port 221. The valve block 220 can include a single valve port 221 and be dedicated to a single valve assembly 210, or, as illustrated, may include multiple valve ports 221, 221′, 221″ and support multiple valve assemblies 210, 210′, 210″. A given power machine may have a single valve block such as valve block 220 or a plurality of valve blocks as may be advantageous. The port identification tag 222 includes identification information for the block 220, the valve port 221, or both. The stem identification tag 231 includes identification information for the stem 230. The port identification tag 222 and the stem identification tag 231 may uniquely identify the respective valve port 221 and valve stem 230, or may identify the type, classification, or size of the valve port 221 and valve stem 230. The block and stem identification tags 222, 231 can include, but are not limited to, a RFID tag, bar code, or any other machine-readable identifier that encodes relevant information. The port identification tag 222 may be incorporated in or positioned proximate the valve port 221. The stem identification tag 231 may be incorporated in the stem 230. The term “incorporated” and variations such as “incorporates” and “incorporating” used herein may refer affixing near or to, integrating in, or otherwise making a part of.

The valve stem 230 permits and restricts a flow of hydraulic fluid through the valve port 221. In the illustrated example, the valve stem 230 is threaded into the valve port 221, so that a tube 232 is positioned within the valve port 221. The tube 232 houses a movable spool valve portion (not shown in FIG. 2) that moves linearly in the valve stem 230 (including in tube 232) to completely or partially close and open flow ports in the stem 230 to various ports (not shown in FIG. 2) in block 220 that are in communication with the valve port 221 to allow pressurized hydraulic fluid flow into the various ports. The tube 232 is shown without port apertures for simplicity's sake. In actual embodiments, apertures are provided on the outside surface to engage various ports in the block 220 when the valve stem is threaded into valve port 221. In other embodiments, valve stem 230 does not include a tube such as tube 232, and instead the spool itself is positioned adjacent an inner surface of the valve port 221. The actuator 240 may be an electronically operated actuator (e.g., a solenoid) or another type of actuator as are known in the art. The actuator 240 receives power through power lines 241 and 242 that are connected to the actuator 240 through the wiring connector 252.

The communication link 250 places the reading device 260 in communication with the electronic controller 200, such that identification information from the identification tags 222 and 231 is supplied to the electronic controller 200. The electronic controller 200, in one embodiment, includes multiple channels or output ports, one dedicated to each valve assembly 210. Alternatively, the controller 200 can be connected to each of the valve assemblies 210 over a communication network (not shown in FIG. 2). The communication link 250 may communicate between one of the plurality of output ports on the electronic controller 200 and one of the electrically operated actuators 240. The communication link 250 may be wired or wireless. In the wired form, the communication link 250 can include a control wire 251 for each of the electrically operated actuators 240 and a wiring connector 252 attachable to the actuator 240. The power lines 241 and 242 may generally be considered part of the communication link 250. Through the communication link 250, the controller 200 receives identification information and controls operation of the valve assembly 210.

The reading device 260 reads identification information from each of the port identification tag 222 and stem identification tag 231. The reading device 260 may include a radio frequency transceiver or another type of device that is capable of accessing identification information from the type of identification tags 222 and 231 that are employed. The reading device 260 communicates with the communication link 250 by way of wireless or wired communication path 261.

In operation, the reading device 260 reads identification information from the port identification tag 222 and the stem identification tag 231 and transmits the read information to the electronic controller 200 via the communication link 250. In embodiments such as is shown in FIG. 2, where the valve block 220 has multiple valve ports 221, 221′, and 221″, the electronic controller 200 can determine which valve stem 230, 230′, and 230″ is associated with each valve port 221, 221′, and 221″. The electronic controller 200 can further determine whether each valve stem 230, 230′, and 230″ is appropriate for the associated valve port 221, 221′, and 221″. The electronic controller 200 controls operation of the electronic actuators 240, 240′, and 240″ through the communication link 250. Because the controller 200 has mapped the valve stem/actuator assembly 230, 240 to a specific valve port 221, the controller 200 can properly execute operations pursuant to the inputs of the operator through the user input devices 119. In this regard, as long as the valve stem 230 is of an appropriate type (e.g., on/off or infinitely adjustable) for the valve port 221 into which it is inserted, the controller 200 will accept the combination. The controller 200 does not require that a specific valve stem 230 be plugged into a specific valve port 221 or that a specific wiring connector be attached to a particular actuator 240 because the controller will map the relationship based on the identification tags 222 and 231 and be able to execute the operator commands; the controller 200 can adapt to mis-wiring of the valve block 220. In the case where the controller 200 determines that a given stem and the valve port to which it is associated is a mismatch, the controller 200 can alert an operator and/or take various steps to reduce or change the functionality as necessary in response to the identified mismatch.

A method 400 for operating a control system valve assembly of the type illustrated in FIG. 2 is detailed in a flowchart illustrated in FIG. 3. The method 400 includes incorporating a port identification tag 222 is incorporated with a valve port 221 in the valve block 220 (shown at block 410), incorporating a stem identification tag 231 with the stem 230 (shown at block 420), and incorporating a reading device 260 with the actuator 240 (shown at block 430). The processes identified in blocks 410, 420, and 430 can be performed in any order. Incorporating the port identification tag 222 with the valve port 221 and the stem identification tag 231 with the stem 230 shown in blocks 410 and 420 may include assigning unique tags 222, 231 with the valve ports 221 and stems 230 or assigning tags 222, 231 that identify classes or sizes of the respective valve ports 221, 230.

At block 440, the method 400 includes reading the identification information from the port identification tag 222 and the stem identification tag 231. This read identification information is communicated to the electronic controller 200 at block 450, via, for example, the communication link 250.

An optional error-checking routine is detailed in blocks 460, 461, 462, and 463. At block 460, the read identification information is compared with expected combinations of valve stems 230 and valve blocks 220. In some embodiments, the comparison includes identifying the position of each valve stem 230 in the valve block 220 by pairing each stem identification tag 231 with the associated port identification tag 222, and storing all of the combinations in memory. At block 461, the controller 200 determines whether an expected combination is met or satisfied, that is, whether the read identification information related to associations between each of the valve stems 230 and valve ports 221 matches expectations. If an expected combination is not met, the controller 200 identifies an exception condition as shown at block 462. The exception conditions may be specific (e.g., a specific valve stem 230 with a specific serial number is erroneously plugged into a valve port 221 having an unexpected serial number), intermediate (e.g., an incorrect class or size of a valve stem 230 is plugged into a particular valve port 221), or general (e.g., at least one of the valve stems 230 is in an incorrect valve port 221) in nature. The controller 200 then authorizes a notification routine that notifies an operator at block 463 of the identified exception condition. This can be accomplished in a variety of ways, such as through audio and/or visual indicators. Controller 200, in some embodiments, provides information to an operator information device such as a display and/or audible device to control the notification.

Once the identification processes discussed above are completed, the method next commences to operate each actuator 240 as needed for a particular operation as is shown in block 465. The electronic controller 200 uses the identification information to ensure that the proper valve assemblies 221 are actuated to achieve the desired function of the power machine 100 through the control system 142. This may include (if it has not been previously done, e.g., in the error checking subroutine) identifying the position of each valve stem 230 in the valve block 220 by pairing each stem identification tag 231 with the associated port identification tag 222, and storing all of the combinations in memory. With the combinations stored in memory, the controller 200 can map the combinations of valve stems 230 and actuators 240 to the respective valve ports 221 so the controller 200 can implement the commands of the operator received by the controller through the user input devices 119.

In other configurations, the process at block 465 may include comparing the identification information to a plurality of valve stem 230 and valve port 221 combinations, each of the combinations having associated operating parameters, selecting one of the plurality of combinations that matches the identification information and operating the valve assembly 210 according to the operating parameters associated with the selected combination.

The systems and methods above provide for important advantages. Power machines that have valve blocks with many valve stem and valve port combinations were previously susceptible to assembly errors, primarily related to pairing valve stems with valve ports and attaching wiring connectors to actuators. The systems and methods described above work to identify the valve stem and valve port combinations and when an unexpected combination is found, an operator is notified. The systems further allow for wiring flexibility. Having several actuators in close proximity with each actuator having a connector that is to be attached, allowing for any of the several connectors to be attached to any of the several actuators eliminates the need to make sure that each actuator is attached to the correct wiring connector. This makes for easier assembly of the power machine.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, in various embodiments, different types of power machines 100 can be configured to employ the valve identification system. Other examples of modifications of the disclosed concepts are also possible, without departing from the scope of the disclosed concepts.

What is claimed is:

1. A method for identifying and operating a control system valve assembly through an electronic controller, the valve assembly comprising a valve port, a valve stem removably inserted in the valve port, and an actuator connectable to the valve stem and actuable to control a flow of hydraulic fluid through the valve port, including:
incorporating a port identification tag with the valve port, the port identification tag including identification information for the valve port;
incorporating a stem identification tag with the stem, the stem identification tag including identification information for the stem;
incorporating a reading device with the actuator;
reading the identification information from the port identification tag and the stem identification tag with the reading device;
communicating the identification information read by the reading device to the electronic controller; and
operating the valve assembly with the electronic controller based on the identification information in response to operating commands.

2. The method of claim 1, wherein the valve port is included in a valve block that includes multiple valve ports; and wherein incorporating a port identification tag with the valve port includes incorporating a port identification tag with each valve port in the valve block, such that each valve port in a valve assembly includes a unique port identification tag.

3. The method of claim 2, further comprising identifying the position of the valve stem in the valve block through the port identification tag associated with the valve port in which the valve stem is received.

4. The method of claim 1, wherein incorporating a port identification tag with the valve port includes providing the port identification tau in the form of a radio frequency identification tag; and wherein incorporating a reading device with the actuator includes providing the reading device in the form of a radio frequency transceiver.

5. The method of claim 1, wherein the electronic controller is programmed with expected combinations of valve stem identification information and valve port identification information; the method further comprising: comparing the valve stem identification information and valve port identification information to the expected combinations; and identifying an exception condition if an expected combination is not met.

6. The method of claim 5, further comprising: providing an indication to an operator of the identified exception condition.

7. The method of claim 1, wherein the actuator includes a solenoid that electronically communicates with the electronic controller through a communication link; wherein the solenoid is controlled by the electronic controller through the communication link; and wherein communicating the identification information read by the reading device includes communicating the valve port and valve stem identification information to the electronic controller from the solenoid through the communication link.

8. The method of claim 7, wherein the communication link includes a control wire and a wiring connector attachable to the solenoid.

9. The method of claim 1, wherein the valve assembly includes a plurality of valve assemblies; the method further comprising: mapping the valve assemblies with the processor; and wherein operating the valve assembly includes operating the correct valve assemblies, based on mapping the valve assemblies, to accomplish the operating commands.

10. The method of claim 1, wherein operating the valve assembly includes comparing the identification information to a plurality of valve stem and valve port combinations, each of the combinations having associated operating parameters, selecting one of the plurality of combinations that matches the identification information and operating the valve assembly according to the operating parameters associated with the selected combination.

11. A control assembly including:
an electronic controller;
a plurality of valve assemblies, each valve assembly comprising a valve port including a port identification tag, a valve stem received in the valve port and including a stem identification tag, and an actuator connected to the valve stem, each actuator including a reading device for reading identification information from each of the port identification tag and stem identification tag; and
a communication link between the reading device of each valve assembly and the electronic controller, such that the electronic controller receives the identification information for each valve port and stem arrangement of each valve assembly;
wherein the electronic controller operates the valve assemblies according to the identification information to perform a desired operation.

12. The control assembly of claim 11, wherein the electronic controller includes a plurality of output ports; wherein the valve assemblies are adapted for use in a control system; wherein the valve stems are adapted to permit and restrict a flow of hydraulic fluid through the valve ports; wherein the actuators are electronically-operated actuators; and wherein the communication link includes a control wire for each of the electronically-operated actuators communicating between one of the plurality of output ports on the electronic controller and one of the electronically-operated actuators.

13. The control assembly of claim 11, wherein the electronic controller controls each actuator at least partially based on the identification information.

14. The control assembly of claim 11, wherein the electronic controller is incorporated with a power machine having a control system that includes the valve assemblies; and wherein the electronic controller controls at least one function of the power machine through the control system.

15. The control assembly of claim 14, wherein an implement is selectively attached to the power machine, the implement including a control system for performing work, the implement control system interfacing with the power machine control system; and wherein at least one of the plurality of valve assemblies is incorporated with the implement.

16. A power machine including:
an electronic controller;
a plurality of user input devices in communication with the electronic controller, such that commands provided by the operator through manipulation of the user input devices are received by the electronic controller;
a control system including a plurality of valve assemblies, each valve assembly including a valve port, a valve stem in the valve port, and a valve actuator interconnected to the valve stem and actuable to control a flow of hydraulic fluid through the valve port;
a valve port identification tag incorporated with each valve block;
a stem identification tag incorporated with each valve stem;
a reading device incorporated with each valve actuator, the reading device receiving identification information from the valve port identification tag and stem identification tag in the valve assembly; and
a communication link between each valve assembly and the electronic controller;
wherein the electronic controller receives the identification information from each valve assembly and thereby determines a position of each valve stem in the control system;
wherein the electronic controller executes the commands received from the operator through the user input devices by actuating the appropriate valve assemblies; and
wherein the electronic controller controls at least one function of the power machine through the control system.

17. The power machine of claim 16, further comprising an attachable implement that interfaces with the control system; and wherein at least one of the plurality of valve assemblies is incorporated with the attachable implement.

18. The power machine of claim 16, wherein the actuators are electronic actuators; wherein the communication link includes a control wire interconnected between each of the electronic actuators and the electronic controller; wherein the identification information is supplied to the electronic controller through the control wires; and wherein the electronic controller controls operation of the electronic actuators through the control wires.
